(19) United States
(12) Patent Application Publication
(10) Pub. No.: US 2003/0070461 A1
(43) Pub. Date: Apr. 17, 2003

(54) Poultry litter fertilizer

(76) Inventor: Michael Ferguson, Salisbury, MD (US)

Correspondence Address: Supervisor, Patent Prosecution Services, PIPER MARBURY RUDNICK & WOLFE LLP, 1200 Nineteenth Street, N.W., Washington, DC, 20036-2412, US

(21) Appl. No.: 09/973,750

(22) Filed: Oct. 11, 2001

(51) Int. Cl. C05F 3/00

(52) U.S. Cl. 71/21

(57) ABSTRACT

A system and method for manufacturing fertilizer nutrients from poultry litter. The method of the invention includes heating and pasteurizing raw material; drying the heated and pasteurized material; reducing the dried material to a powder; and pelleting the powder to granular and homogenized pellets. The poultry litter fertilizer is high in nitrogen and provides a good source of nutrients for many crops.

### BACKGROUND OF THE INVENTION

1. Field of the Invention

This invention generally relates to fertilizers and, more specifically, to a system and method for manufacturing fertilizers from poultry litter.

2. Description of Related Art

Poultry litter is one of the most valuable litters produced by livestock. Poultry litter is a very good source of plant nutrients and soil amendment when properly processed. In particular, poultry litter is managed primarily for its nitrogen (N) value. However, nitrogen availability from poultry litter is the most difficult of the three primary nutrients (nitrogen (N), phosphate (P₂O₅) and potassium (K₂0)) to predict. About one-third of the total nitrogen in poultry litter is in the ammonium form (NH₄—N) and the rest is in an organic form. The amount of nitrogen available for plant uptake is ammonium nitrogen plus the amount of organic nitrogen that mineralizes during the growing season. Poultry litter has the following average nutrient content: a fertilizer grade of about 3-3-3 (N—P₂O₅—K₂O); total nutrients of about 60-60-60 (lbs/ton); and available nutrients of first season of about 40-40-30 (lbs/ton).

Poultry litter is most valuable immediately after it is removed from the poultry house. The nitrogen in the litter can be preserved if it is stored in an enclosed structure (e.g., dry storage barn) or in a deep covered pile. Poultry litter should be handled like commercial fertilizers and should not be stored outside and exposed to the weather. Litter stored outside and exposed to the weather will decompose rapidly, and rain can leach valuable nutrients into surface waters. Moreover, when poultry litter is exposed to air and moisture, the ammonium form of the total nitrogen (NH₄—N) is converted to the organic form. This composted litter or litter that has been exposed to the weather over time is less valuable to the crop. Currently, there is no effective and environmentally sound solution for managing surplus poultry litter and, thus, there is a need for an effective system and method for manufacturing fertilizers from poultry litter.

### SUMMARY OF THE INVENTION

Exemplary embodiments of the invention include systems and methods for manufacturing fertilizer nutrients from poultry litter. Features of the invention include heating and pasteurizing raw material; drying the heated and pasteurized material; reducing the dried material to a powder; and pelleting the powder to granular and homogenized pellets. The poultry litter fertilizer is high in nitrogen and provides a good source of nutrients for many crops.

### BRIEF DESCRIPTION OF THE DRAWINGS

The accompanying drawings, which are incorporated in and constitute a part of the specification, illustrate exemplary embodiments of the invention and, together with the detailed description of the invention, explain various aspects and principles of the invention.

FIG. 1 is an illustration of a system for manufacturing fertilizer from poultry litter in accordance with an exemplary embodiment of the invention; and

FIG. 2 is a flowchart illustrating a method for manufacturing fertilizer micronutrients according to an exemplary embodiment of the invention.

### DETAILED DESCRIPTION OF THE INVENTION

The following detailed description refers to the accompanying drawings that illustrate exemplary embodiments of the invention. Other embodiments are possible and modifications may be made to the exemplary embodiments without departing from the spirit and scope of the invention. Rather, the scope of the invention is defined by the appended claims.

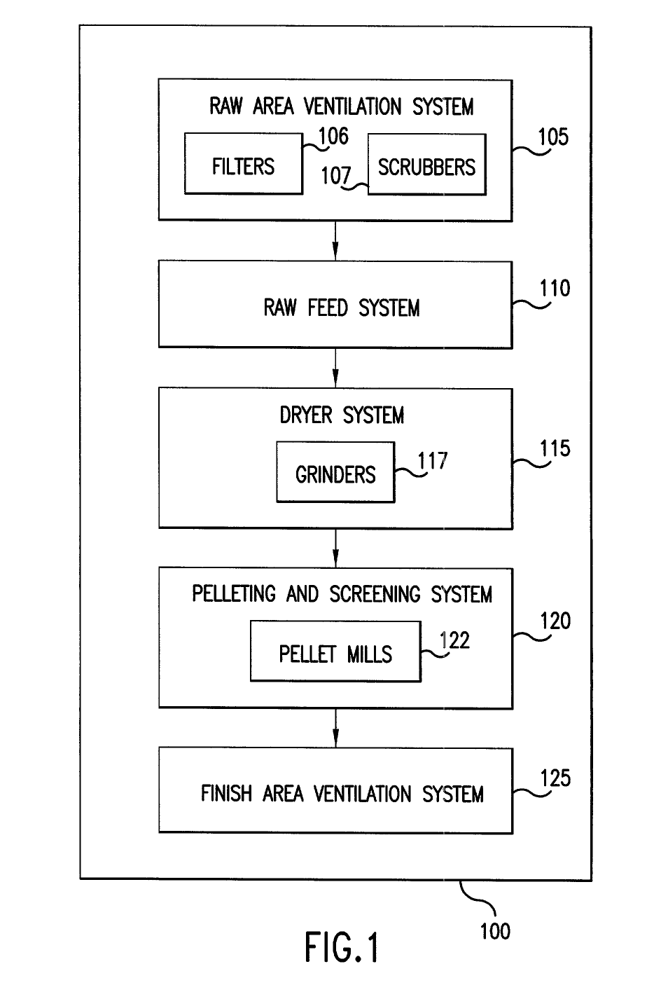

FIG. 1 is an illustration of a plant 100 for manufacturing fertilizer from poultry litter in accordance with an exemplary embodiment of the invention. The fertilizer manufacturing plant 100 includes a raw area ventilation system 105, a raw feed system 110, a dryer system 115, a pelleting and screening system 120, and a finish area ventilation system 125. To begin, surplus litter is transported from farms to the fertilizer manufacturing plant 100 by specially-designed, sealed trucks so as to preserve the nitrogen in the litter. The trucks unload the surplus litter inside the fertilizer manufacturing plant 100, where the raw area ventilation system 105 operates to prevent dust and odor from escaping to the environment. The raw area ventilation system 105 includes special filters 106 and scrubbers 107 that ensure that the air leaving the plant is just as clean or cleaner than the outside air. That is, in an air treating process, scrubbers 107 strip all the odor causing compounds out of the air before emitting it to the atmosphere. The raw feed system 110 segregates the wet and dry raw material or litter and feeds the raw material or litter to the dryer system 115. The dryer system 115 heats and pasteurizes the raw material so as to remove and destroy bacteria. The dryer system 115 includes grinders 117 that reduce the dried material to a powder before it is transferred to the pelleting and screening system 120. Moisture captured in the air treating process may be re-used in the pelleting and screening system 120 to balance moisture content. The pelleting and screening system 120 produces pellets comprising primarily of organic matter and humus as further described herein. It is preferable that the pelleting and screening system 120 includes two pellet mills 122, each operating at 500-horsepower and capable of producing 10 tons of pellets per hour. The pellets are approximately 1-6.5 mm long. The pellets are very useful for commercial row crop operations that are suffering from micronutrient deficiencies or low organic matter. The finished pellets are cooled and stored in a finished product room, which is regulated by the finish area ventilation system 125. The finish area ventilation system 125 is similar to the raw area ventilation system 105. The finished product can then be loaded into trucks or rail cars for bulk shipment to nutrient deficient regions.

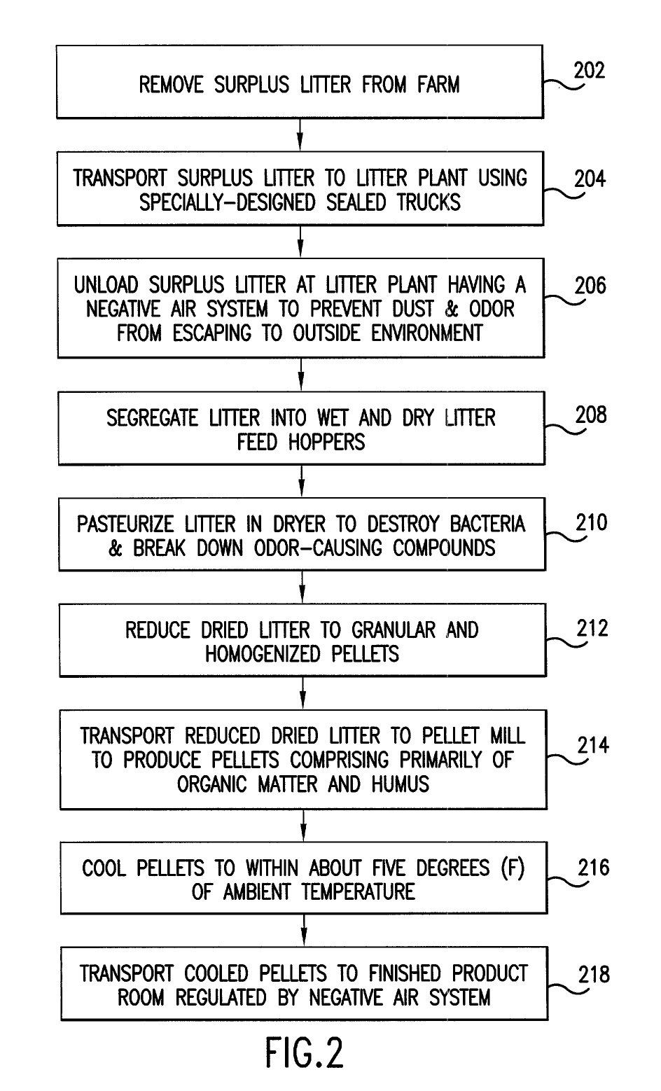

FIG. 2 is a flow diagram illustrating a poultry litter fertilizer manufacturing process in accordance with an exemplary embodiment of the invention. Poultry producers often have surplus litter from their farms. A first step in the process is to remove the surplus litter from the farms in step 202. Next, the surplus litter is transported to another plant or site where it can be processed to micronutrients in step 204. The surplus litter, for example, may be loaded into specially designed, covered and leak-proof aluminum trailers dedicated for transport to a pellet processing plant. At 206, the litter trucks are unloaded in a raw material room of the pellet processing plant, where a negative air system changes several times an hour, e.g., 10 times per hour, so as to prevent dust and odor from escaping to the outside environment. The wet and dry litter is segregated into designated feed hoppers at 208 with a front-end loader before moving to a dryer.

The negative air system is an air-filtration system that ensures that no odor or dust is emitted into the environment. In particular, thermal energy is used to break down the chemical properties of odor-causing compounds. The air-filtration system is preferably 99.9 percent efficient in eliminating odor.

The negative air system includes scrubbers for removing odor from the air. The treated air contains moisture, which is captured and re-used in the pelleting process as further described herein. At 210, the litter is pasteurized in a dryer to destroy bacteria. The litter should be heated to about 180° F. to 225° F. Next, at 212, the dried litter is reduced to a consistency of fine sand by, e.g., a hammer mill. The reduced dried litter is then transported to a pellet mill at 214, which produces pellets comprising primarily of organic matter and humus.

The pellets produced by the pellet mills are hot, typically 200° F., and need to be cooled to within about five degrees (F) of ambient temperature as shown at 216 so as to ensure product quality. At 218, the cooled pellets are transported to a finished product room via a system of conveyors and elevators. The finished product room operates on a similar negative air system used in the raw material room. The finished product room (of the pellet plant) can store 7,000 tons of pellets. The pellets are loaded with a front-end loader onto an in-ground conveyor and transported to waiting rail cars and trucks. The finished product is tested on a regular basis (e.g., weekly) by an in-house and/or an outside agency for quality control. Each pellet plant is capable of loading 30 rail cars in 24 hours or the equivalent of about 350 tons per hour. The finished product is shipped to nutrient deficient regions internationally.

The invention offers poultry producers an environmentally sound solution for managing surplus poultry litter. The invention recycles both valuable nutrients and organic material without creating any waste byproducts. The final product of the invention—pasteurized, all-natural fertilizer pellets called MicroStart60® (MicroStart60® is a registered trademark for a fertilizer of Perdue-AgriRecycle LLC)—can be easily shipped from poultry-producing areas to nutrient-deficient regions across the country and around the globe. In particular, MicroStart60® is a fertilizer comprising a wide variety of micronutrients, humus and organic matter that help produce significant increases in normal crop yields year after year. MicroStart60® is ideal for commercial row crop farming, i.e., MicroStart60® is especially formulated for precision agriculture so as to increase crop yield and health. MicroStart60® helps crops take up more nutrients while adding humus, organic matter and essential trace elements back into the soil and, thus, it improves vital water retention. MicroStart60® also includes proper amounts of Nitrogen (N), Phosphate (P₂O₅), Potassium (K₂O), and other important secondary nutrients and trace elements that are vital to healthy plant growth. By incorporating MicroStart60® into a current fertilizer program, one can expect to maximize the soil's nutrient content as well as its nutrient availability. In other words, MicroStart60® acts like a surfactant, making a chemical fertilizer work harder and last longer.

MicroStart60® comprises micronutrients and about 60% organic matter for commercial row crop farming and precision agriculture. Features of MicroStart60® include: improved organic components of the soil; increased water retention in the soil; harder working and longer lasting chemical fertilizer; improved nutrients that prevent runoff and resultant nutrient loss; a 3-4-3, 3-3-3, or 4-4-3 Nitrogen-Phosphorous-Potassium (N—P—K) nutrient content (it should be noted that poultry litter has the highest percent of N—P—K of any available natural fertilizer); improved exchanged capacity of the soil and its pH buffering ability; long term benefits to the soil, as opposed to short-term benefits of common chemical fertilizer; providing water insoluble nitrogen that is released slowly over a long period of time; providing a residual value that can feed next year's crop and the soil life within the soil; providing pellets that flow easily and broadcast evenly through both conventional and air flow spreaders; and approval by the Organic Materials Review Institute for organic crop production.

What is claimed is:

1. A process of recycling litter to make fertilizer, comprising:
pasteurizing raw material comprising poultry litter;
drying the pasteurized material;
reducing the dried material to a powder; and
pelleting the powder to granular and homogenized pellets.

2. A fertilizer produced according to the process of claim 1.

3. The process of claim 1, further comprising scrubbing the litter to reduce odor.

4. The process of claim 1, wherein the litter is heated from about 180° F. to 225° F. during the pasteurizing stage.

5. The process of claim 1, wherein the pellets are about 1 mm to 6.5 mm long.

6. The process of claim 1, wherein the pellets comprise of organic matter and humus.

7. The process of claim 1, further comprising entrapping odor of the litter.

8. The process of claim 3, wherein scrubbing the litter produces moisture.

9. The process of claim 8, wherein the moisture from scrubbing is captured and re-used in the pelleting stage.

10. A poultry litter fertilizer manufacturing system, comprising:
a raw material ventilation system including a scrubber for treating air by removing odor from the air;
a dryer system for
pasteurizing raw material comprising poultry litter,
drying the pasteurized material, and
reducing the dried material to a powder; and
a pelleting system for producing granular and homogenized pellets from the powder.

11. The system of claim 10, wherein the air treating by the scrubber produces moisture.

12. The process of claim 11, wherein the moisture from the air treating is captured and re-used in the pelleting system.

13. The process of claim 10, wherein the pelleting system comprises two pellet mills, each pellet mill capable of producing 10 tons of pellets per hour.

14. The process of claim 10, further comprising a finish area ventilation system for cooling and storing the pellets.

15. The process of claim 10, wherein the dryer system heats the raw material from about 180° F. to 225° F. during pasteurization.

16. The process of claim 10, wherein the pellets are about 1 mm to 6.5 mm long.

17. The process of claim 10, wherein the pellets comprise of organic matter and humus.
